(19) United States
(12) Patent Application Publication
(10) Pub. No.: US 2023/0334495 A1
(43) Pub. Date: Oct. 19, 2023

(54) LOCAL TRANSACTION AUTHORIZATION USING BIOMETRIC INFORMATION PROVIDED BY A USER DEVICE

(71) Applicant: Simpello LLC, Monticello, IN (US)

(72) Inventor: William Benjamin Robertson, Monticello, IN (US)

(73) Assignee: Simpello LLC, Monticello, IN (US)

(21) Appl. No.: 18/338,618

(22) Filed: Jun. 21, 2023

Related U.S. Application Data
(63) Continuation of application No. PCT/US2021/064309, filed on Dec. 20, 2021.
(60) Provisional application No. 63/128,956, filed on Dec. 22, 2020.

(51) Int. Cl. G06Q 20/40; G06Q 20/20; G06V 40/16; G06V 40/20

(52) U.S. Cl. CPC G06Q 20/40145; G06Q 20/20; G06V 40/172; G06V 40/20

(57) ABSTRACT

A wireless device system employs short-range wireless communication to require the local biometric authentication of a user prior to completing a desired transaction. In order to achieve this authentication, a mobile device connects to a local terminal and provides, along with the identifying information, a confirmed biometric profile of the user. At the time the transaction is to be completed, the terminal, which is equipped with a biometric sensor such as a camera, seeks to confirm that the user in the defined zone seeking to make the transaction matches the biometric profile submitted by the user's device. In this manner, the biometric verification is performed entirely by the terminal, independent of the user's phone, and without the need to connect to a centralized (and thus remote) server.

### CROSS-REFERENCE TO RELATED APPLICATION

This application is a continuation of International Patent Application No. PCT/US2021/064309, filed Dec. 20, 2021 which claims the benefit of U.S. Provisional Application No. 63/128,956 filed Dec. 22, 2020, each of which is hereby incorporated by reference.

### FIELD OF THE INVENTION

The present invention generally relates to a transaction authorization system including a wireless user device and a transaction processing terminal. More particularly, the present invention pertains to a transaction authorization system which provides an additional authentication factor through the local verification of biometric information provided by the wireless user device.

### BACKGROUND

In the United States alone there were nearly 40 billion credit card purchase transactions completed in 2019. In addition, debit cards, gift cards and other electronic payments represent a growing number of additional transactions. All of these transactions are subject to fraud risk, which results in billions of dollars of losses per year, as well as significant consumer inconvenience. Much of this fraud has been enabled by the credit card's abandonment of signature matching, which were implemented early on with the evolution of charge cards. To combat fraud and further secure these transactions, credit card issuers have turned to the EMV chip, which is embedded into each credit card and read by the corresponding terminal. While the EMV chip has been successful in reducing certain types of fraud, it has not been able to provide true two-factor security as the card and chip remain together.

It is clear that the path to reigning in credit card and transaction fraud is to require a two factor authentication. However, no one wants to slow down the consumer in making legitimate purchases, even it allows for more fraud. Other solutions for transaction verification have included fingerprint verification, which is one type of biometric verification. However, this requires an overt act by the consumer, and requires additional time. Traditionally, this method of verification required the transaction processor to obtain and validate biometric information from each authorized user, securely store it, and remain available to verify biometric information sent in with a pending transaction in order to quickly verify the same. As can quickly be seen, this process requires substantial overhead and requires a transaction terminal to communicate with remote servers in order to verify the biometrics presented by the user. All of this is undesirable as it slows things down.

What is needed is a biometric authentication which is virtually transparent to the user. This requires that the authentication not require overt user action or significant overhead and be capable of being processed locally. Fortunately, smartphone adoption in the United States has grown rapidly from less than 6% of the population in 2007 to more than 80% of the population today, with the majority of all heavy and/or high-end retail consumers having such a device. Currently, smartphones are being used for payment, GPS tracking, music streaming, access control, security and a wide range of other purposes unrelated to traditional telephony. Such widespread use by consumers, travelers and employees provides numerous opportunities for businesses, government and facilities to passively identify and/or interact with these devices and their user. However, very few uses have gone so far as to utilize smartphones (or other similar devices) to facilitate a trusted and local biometric verification of the user identity independently of the payment method. The present invention leverages this wide deployment of smartphones to accomplish a much needed secure and seamless two-factor authentication process that doesn't necessarily rely on a payment provider or a mobile phone provider.

This disclosure is applicable to all areas where the verification of an identifiable customer or other individual enables one or more desired transactions or secured action(s), such as a retail purchase, entrance or access to a structure, vehicle, venue, or any other type of restricted area. For routine sales transactions, such as a coffee purchase or fast-food items, the use of the proximity of a smartphone to a vending machine or sales counter may be sufficient to authorize a sales transaction without adding another layer of confirmation to the transaction. However, a biometric verification according to the present invention may be required and serve as a two factor authentication for other transactions where the risk is greater, such as a purchase over a predetermined threshold, in an area outside of the user's hometown or the like. Of course, the second factor may also be utilized for all transactions, if desired.

In another form, the verification of biometric information may serve to validate an airline ticket or boarding pass, concert ticket or the like. The systems disclosed herein seek to accomplish this type of transaction (hereinafter called “StrictID” or the “StrictID system”). Some transactions may not require a payment but will require the user to verify his/her identity before they are accepted, such as creating new accounts at a bank, accessing and making changes to a medical file, etc.

In addition, other potential and non-limiting applications will be discussed herein.

### BRIEF DESCRIPTION OF THE DRAWINGS

FIG. 1 is a diagrammatic view of one embodiment of a transaction authorization system according to the present invention.

FIG. 2 is a flowchart illustrating one set of steps involved in an illustrative process for provisioning a mobile phone for use in completing a secure two-factor transaction with a terminal, as shown in FIG. 1, according to one form of the present invention.

FIG. 3 is a flowchart illustrating one set of steps involved in an illustrative process for completing a verified transaction using the shown in FIG. 1, according to one form of the present invention.

FIG. 4 is a representative mock-up of the view captured by a camera viewing into the transaction zone of FIG. 1 according to one form of the present invention.

### DETAILED DESCRIPTION OF THE INVENTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Currently, commercial biometric systems exist for granting access/entry to physical locations or computer systems, serving as a second factor for financial transactions and many other uses. However, all such systems which may be utilized for processing consumer transactions require a central repository, such as a server or database, which stores trusted biometric information and subsequently remains active to receive biometric verification requests. In addition, each often requires a specific dedicated biometric sensor which requires an over act from the user, such as a fingerprint scan, retinal scan or the like in order to submit their biometric information for verification. On top of this, the user is often required to travel to and participate in an extensive on-boarding process in order to securely collect the biometric profile to be stored and subsequently used for verification by the central repository. As such, many problems exist in the prior art which are solved by the local transaction authorization system of the present invention.

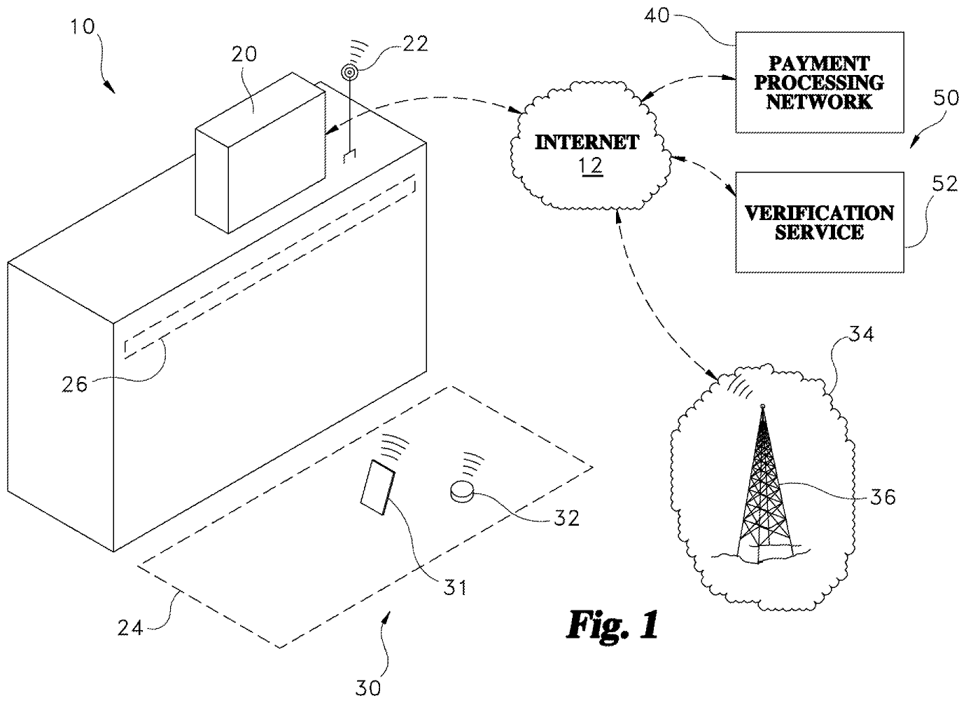

As shown in FIG. 1, one embodiment of a transaction authorization system which advantageously permits a user to securely authorize a transaction at a terminal in conjunction with a wireless device. In addition to transactional systems, such as commercial checkout terminals, it will be appreciated that similar embodiments of the transaction authorization system described herein may also encompass systems for permitting the secured redemption of a ticket, such as for a sporting event or a concert, an airline ticket or boarding pass, and many other transactions which would benefit form a second factor of authentication.

In the illustrated embodiment, according to FIG. 1, the described system comprises transaction authorization system 10 for allowing customers to complete a transaction at a terminal 20 using a wireless device 30, which in the preferred form, is the user's Bluetooth capable mobile phone 31 or other wireless appliance 32. Mobile phone 31 is preferably a mobile phone used for mobile voice or data communication over a network 34 of cell towers 36 or other network(s) over which mobile phones such as mobile phone 31 are known to be capable of operation. In addition to the standard voice function of a mobile phone, mobile phone 31 preferably supports many additional services, and accessories, such as SMS for text messaging, email, packet switching for access to the Internet, third-party application download, Bluetooth, infrared, and GPS.

Cellular phone network 34 may comprise a variety of communication networks, including without limitation the universal mobile telecommunications system (UMTS), global system for mobile communication (GSM), and a code division of multiple access (CDMA) network, or similar technology. Cellular phone network 34 utilizes cell tower 36 to establish a wireless bi-directional transmission link between data network 12 and mobile phone 31, which may comprise a wireless data link, such as the Evolution-Data Optimized (EVDO), Enhanced Data rates for GSM Evolution (EDGE), 3G, 4G, LTE, WiMax, or other wireless data connection. Similarly, other wireless appliances 30, such as Palm, Samsung, and Motorola smartphones or other portable wireless appliances or specially created tokens may be configured for use with transaction authorization system 10 through terminal 20 to allow a user to authorize a transaction.

Terminal 20 may be one of various point-of-sale systems, including those provided by Square, Inc. Terminal 20 is preferably connected to a data network 12 via a physically networked and/or wireless connection. Data network 12 is preferably the Internet, which is a TCP/IP based global network; however, the user of the term “Internet” herein shall be understood to refer to at least a portion of any public interconnected electronic network which interchanges data by packet-switching. The connection of terminal 20 to data network 12 enables terminal 20 to communicate with one or more payment processing networks 40, which may each be comprised of a number of servers, services or the like capable of processing one or more of Visa®, Mastercard® and many other common financial transactions or to accomplish other known or novel steps described herein.

Terminal 20 may also include common components such as a user display, customer display, cash drawer, operator user interface, customer user interface, barcode scanner, credit card reader and the like, all of which are not shown as they are common components known to one of skill in the art. Terminal 20 also includes a biometric sensor 22, which in the illustrated embodiment is a camera that is oriented toward the transaction zone 24 where the customer typically stands to complete a transaction. In one form, the camera is a 4K high resolution camera, with a lens and/or view field of view so as to span at least the entire transaction area 24. In addition, the biometric sensor 22 or camera may also include a LIDAR or other sensor type so as to assist in the selected type of biometric verification, which in the illustrated embodiment is facial recognition.

In addition, terminal 20 may be equipped with a very granular proximity detection system 26, such as that disclosed in PCT/US2019/032774 entitled “Radio Frequency Antenna and System for Detecting Presence within a Strictly Defined Wireless Zone, the entirety of which is hereby incorporated by reference. Proximity detection system 26 employs short-range wireless communication to detect the proximity of a user device within a strictly defined wireless zone, such as transaction zone 24, and as a result trigger a desired action, which in the present invention is to either provide authorization for a transaction or biometric verification to proceed, or to identify the precise area of the transaction zone 24 in which the user is standing in order to inform terminal 20 as to which region of the image generated by camera 22 the user's face should appear in. By focusing upon a selected region intelligently, the precision, security and speed of the biometric verification can be further improved.

Also provided as part of system 10 is a Verification Service 50 which operates through a remote server 52 connected to network 12. Verification Service 50 facilitates at least some portion of the set up and operation of the payment and verification functions of system 10, as will be described herein.

It shall be understood that many of the descriptions herein with respect to a retail environment are meant for illustrative purposes and that the concepts herein are generally applicable to other transactions and are not limited to only commercial transactions or retail purchases.

For the avoidance of doubt, commercial transactions shall include, but by no means be limited to, purchases of goods, purchases of services, credit card transactions, debit card transactions, gift card redemptions, e-wallet transactions, crypto currency transactions, wire transfers, ACH transfers and the like.

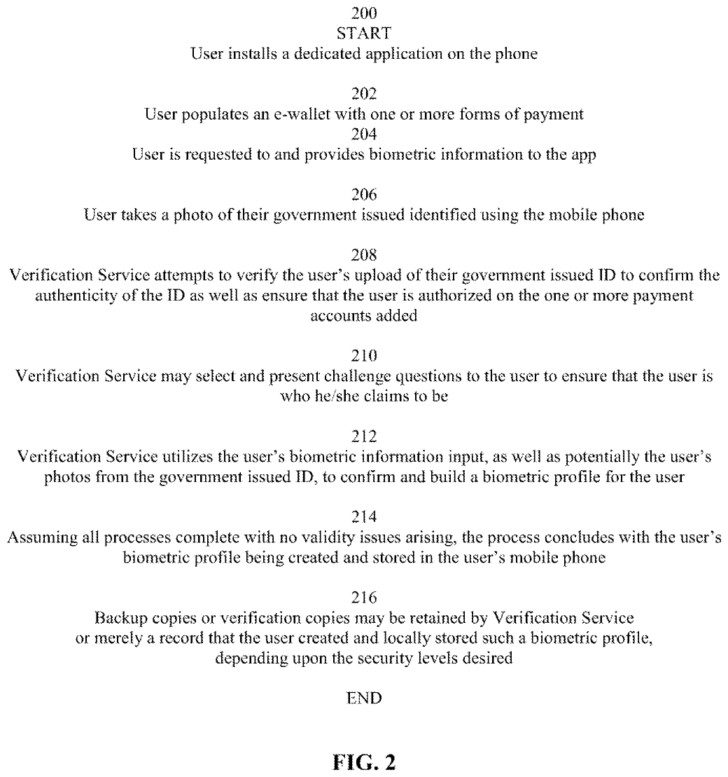

Turning to FIG. 2, one set of steps involved in illustrative process for provisioning a mobile phone 31 for use with terminal 20 is provided. The process begins at start point 200 with the user installing a dedicated application on their mobile phone 31, such as by using an application source such as the Apple App store or the Google Play store. The application may be distributed by the credit card issuer, payment processor, mobile phone provider, retail store, or some other third-party integrator. Once installed, the user populates an e-wallet with one or more forms of payment, such as credit card, debit card or other suitable payment information (stage 202). It shall be appreciated that this information may include a credit card number, expiration date and security code, or other alternative information sufficient to enable to payment. Next, the user is requested to and provides biometric information for themselves to the app (stage 204). This information may be input using a sensor resident on the mobile phone 31, such as a camera, fingerprint scanner, or other sensors thereon. Alternatively, an auxiliary sensor may be provided to the user which is usable with the phone, such as by Bluetooth, USB or other hardwired connection to allow the user to input their biometric information. The auxiliary sensor may be maintained by the user or returned to the service provider, depending upon cost. In other forms, the user may be required to provide their biometric information at a designated location using other equipment.

In a further form, a verification step is required to ensure that the user inputting their biometric information is in fact the person authorized for the various payment methods. This may be accomplished by requiring the user to take a photo of their government issued identified using the mobile phone 31 (stage 206). The photo would include both the user's photo on the ID as well as the barcode or other independently verifiable information thereon. Examples of the government issued ID include a driver's license and a passport. Subsequently, Verification Service 50 attempts to verify the user's upload of their government issued ID to confirm the authenticity of the ID as well as ensure that the user is authorized on the one or more payment accounts added (stage 208). Alternatively, or additionally, the Verification Service 50 may select and present challenge questions to the user to ensure that the user is who he/she claims to be (stage 210). Examples of these questions include street names the user previously lived on, cities in which the user previously resided, the name of entities to whom the user has a loan balance with, or other questions which is often presented in an automated fashion during a background check, credit check or the like.

Thereafter, the Verification Service 50 utilizes the user's biometric information input in stage 204, as well as potentially the user's photos from the government issued ID, to confirm and build a biometric profile for the user (stage 212). Assuming all processes complete with no validity issues arising, the process concludes with the user's biometric profile being created and stored in the user's mobile phone 31 (stage 214). Preferably, this biometric profile is sufficient to enable a user to be verified, but not sufficient to enable a reverse construction of the user's appearance, so as to make any attempted fraud virtually impossible. Backup copies or verification copies may be retained by Verification Service 50, or merely a record that the user created and locally stored such a biometric profile, depending upon the security levels desired. The process ends at end point 216.

It shall be appreciated that various methods of biometric verification exist, including facial recognition, and the use of any of these models herein is contemplated. For example, in the present embodiment, in which facial recognition is utilized, the Verification Service 50 or mobile phone 31 may create the model by pinpointing and measuring facial features from a given image of the user. In further form, a 3-D facial recognition model may be utilized. Moreover, in alternate forms, some or all of the user's biometric profile and/or payment information may be stored by or restricted from Verification Service 50 and/or payment processing networks 40 in order to ensure or ease compliance with GDPR or other data privacy regulations.

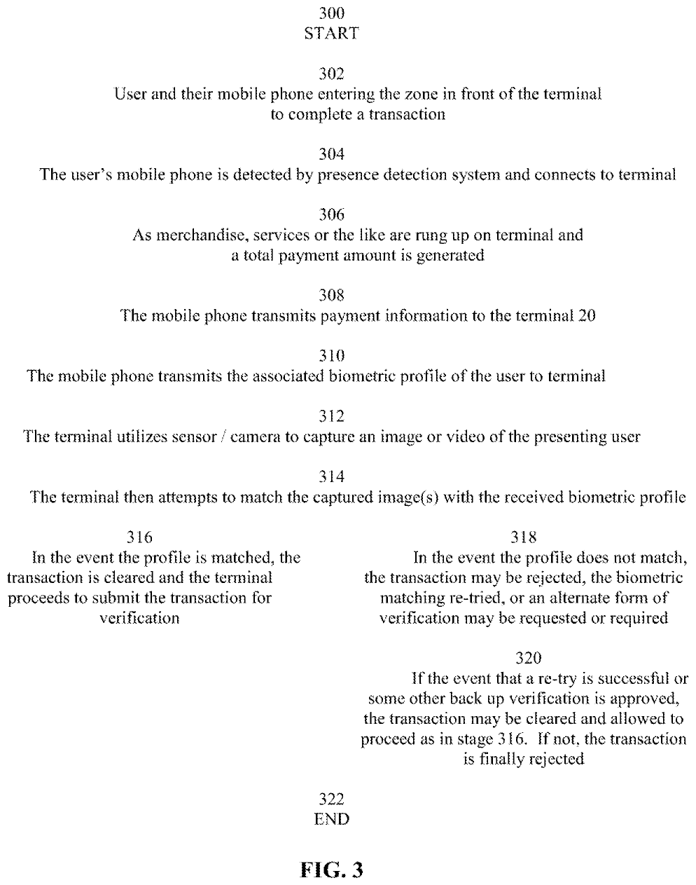

Next, as illustrated in FIG. 3, one set of steps involved in an illustrative process for completing a verified transaction using the system 10 is provided. The process begins at start point 300 with the user and their mobile phone 31 entering the zone 24 in front of the terminal 20 to complete a transaction (stage 302). The user's mobile phone is detected by presence detection system 26 and connects to terminal 20 (stage 304). It shall be appreciated that presence detection system 26 may be removed, and the terminal 20 would perform the role of detecting the presence of a mobile phone 31 more generally and connect thereto. As merchandise, services or the like are rung up on terminal 20, a total payment amount is generated (stage 306). When the final payment amount is determined, or shortly before, the mobile phone 31 transmits payment information to the terminal 20 (stage 308). The exact payment information, such as that of a selected card or account, may be designated by the user through direct input into mobile phone 31, or a previously selected default payment may be provided. In addition, either around or at the same time as the payment information is transmitted, mobile phone 31 transmits the associated biometric profile of the user to terminal 20 (stage 310). Next, the terminal is programmed so as to only permit the submission of the transaction to one of the payment processing networks 40 after the terminal 20 independently verifies that the presenting user matches the associated biometric profile provided by the mobile device 31 along with the payment information. Accordingly, the terminal 20 utilizes sensor/camera 22 to capture an image or video of the presenting user (stage 312). The terminal 20 then attempts to match the captured image(s) with the received biometric profile (stage 314). In the event the profile is matched, the transaction is cleared and the terminal proceeds to submit the transaction for verification to the payment processing networks 40 (stage 316). In the event the profile does not match, the transaction may be rejected, the biometric matching re-tried, or an alternate form of verification may be requested or required, depending upon user, provider and/or retailer preferences (stage 318). If the event that a re-try is successful or some other back up verification is approved, the transaction may be cleared and allowed to proceed as in stage 316. If not, the transaction is finally rejected (stage 320). The process ends at end point 322.

One main advantage of this embodiment of the present invention is the local establishment of a biometric profile within the memory of the user's mobile phone 31 and the passing of this biometric profile to the terminal 20 along with payment information. This establishes a closed loop system and places trust in the terminal to locally verify the received biometric information before proceeding to process the transaction and eliminates the need for the terminal to send the biometric information it identifies out to a remote server for verification, thereby resulting in speed and efficiency improvements. Since the terminal is much less likely to be compromised than a user's mobile device, this arrangement offers many key security advantages.

In a further and even more secure form, the process of FIG. 3 may include an additional factor of authentication prior to clearing the transaction in stage 316. Specifically, the user may be required to input during the initial set up of FIG. 2 a selected gesture, such as waving, tapping their nose, winking, or some other easily recognizable and distinct movement. Thereafter, between the occurrence of stages 308 and 316 the camera 22 would attempt to detect the user performing this gesture. In addition, the terminal 20 may prompt the user to perform this gesture at the conclusion of stage 314, or at some point adjacent thereto, if it has not previously been identified.

In various embodiments, thresholds may be set for the requirement of biometric verification. For example, for common transactions known to occur for a given user, no biometric verification may be required. However, for uncommon transactions above a certain threshold, such as $50, or $100, or for additional controls such as on the purchase of controlled substances, such as alcohol, cigarettes or pharmaceuticals or other medications, the biometric verification step may be required.

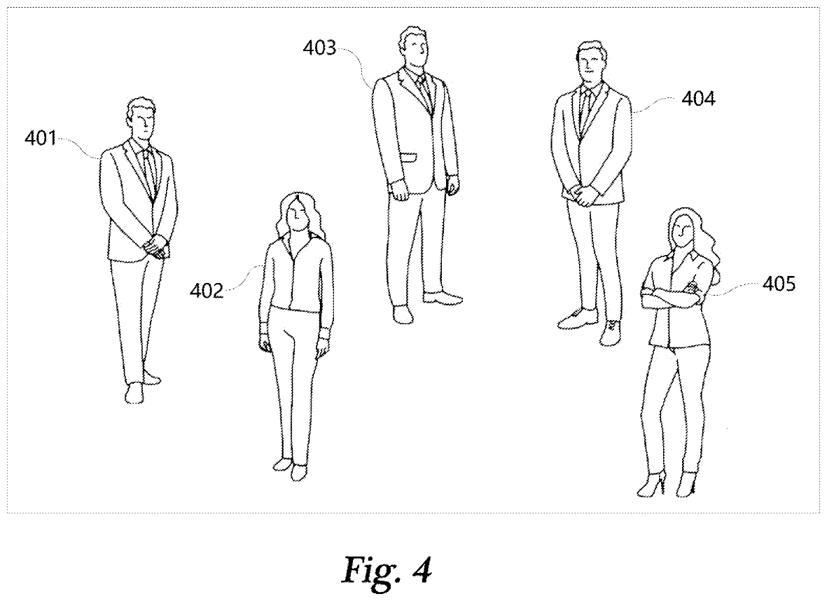

Shown in in FIG. 4 is a mock-up of what the camera 22 might see when viewing into the zone 24. As can be seen, five people are present, person 401, person 402, person 403, person 404 and person 405. By utilizing the proximity detection 26, the terminal 20 is able to determine the approximate position of the mobile device 31 within the zone 24. Assume for example that in this case proximity detection system 26 indicates that the user's mobile phone 31 is in the left side of the zone 24 (as indicated from the camera's perspective), approximately 12″ from the terminal 20 and 1′ from the boundary of the zone 24. This information may be provided using time of flight analysis for the signals transmitted between the system 26 and the mobile phone 31, as well as angle of arrival or departure type information. In addition, the RSSI and other signal analysis and algorithms may also be utilized in the case where the system 26 includes more than one antenna. In such case, the logic within terminal 20 can translate the positional information received from the proximity detection system 26 and, when necessary, identify and focus upon the correct individual within the frame(s) captured by camera 22. In this example, the proximity detection system 26's information identified Person 402. This ensures that the system 10 compares the user holding the mobile phone 31 to the biometric profile provided thereby, and not some other bystander. Additional sensors and algorithms may be used to detect the person being switched at the time of the biometric authentication, avoiding potential user hacks or system errors. In addition to enhancing security, this also serves to increase the speed and accuracy of the system 10 by removing unnecessary work in attempting to verify incorrect individuals.

What is claimed is:

1. A method for authorizing a financial purchase using a transaction authorization system, comprising the steps of:
receiving a request for a financial purchase associated with a payment token, wherein the payment token includes a payment data set and a biometric profile stored thereon, said biometric profile associated with a first authorized user of the payment data set;
receiving the payment data set and the biometric profile from the payment token and not from a remove server;
collecting a first biometric sample using a biometric sensor from a user who presented the payment token;
comparing the first biometric sample with the biometric profile using a biometric processor and determining whether the first biometric sample matches the biometric profile providing an indication as to whether the first biometric sample matches the biometric profile; and
if the indication is that there is no match between the biometric profile and the first biometric sample, rejecting the financial purchase;
and if the indication is that the biometric profile matches the biometric sample, then processing the payment data set to complete the financial purchase using the payment data set.

2. The method for authorizing a financial purchase using a transaction authorization system of claim 1, wherein the payment data set comprises a credit card number and an expiration date.

3. The method for authorizing a financial purchase using a transaction authorization system of claim 1, wherein the biometric profile comprises a facial recognition profile.

4. The method for authorizing a financial purchase using a transaction authorization system of claim 3, wherein the biometric profile is collected by a sensor integrated into the payment token.

5. The method for authorizing a financial purchase using a transaction authorization system of claim 1, wherein the biometric profile comprises at least one fingerprint profile.

6. The method for authorizing a financial purchase using a transaction authorization system of claim 5, wherein the biometric profile is collected by a sensor integrated into the payment token.

7. The method for authorizing a financial purchase using a transaction authorization system of claim 1, wherein the biometric profile is collected by a peripheral sensor temporarily connected to the payment token.

8. The method for authorizing a financial purchase using a transaction authorization system of claim 1, wherein the biometric profile is received directly from the payment token.

9. The method for authorizing a financial purchase using a transaction authorization system of claim 1, wherein the payment token is a smartphone or a smart watch.

10. The method for authorizing a financial purchase using a transaction authorization system of claim 1, wherein the payment data set includes at least one verification data confirmed with a government database.

11. The method for authorizing a financial purchase using a transaction authorization system of claim 1, wherein the verification data comprises a unique identifier printed on a government identification issued to the first authorized user.

12. The method for authorizing a financial purchase using a transaction authorization system of claim 1, further comprising the step of detecting a first gesture from the user who presented the payment token and confirming that the first gesture matches a predefined gesture which is a part of the payment data set.

13. The method for authorizing a financial purchase using a transaction authorization system of claim 1, further comprising the step of using at least one wireless sensor or antenna to determine the position of payment token and direct the biometric sensor to take the biometric sample from the user who presented the payment token.

14. A transaction authorization system for authorizing a financial purchase, comprising:
a payment token having a payment data set and a biometric profile stored thereon, said biometric profile associated with a first authorized user of the payment data set;
a biometric sensor for collecting biometric data from an individual;
a point of sale terminal in electronic communication with the biometric sensor, wherein the point of sale terminal or the biometric sensor includes a data processor having a microprocessor and software for instructing the microprocessor to (a) receive the biometric profile from the payment token and not from a remove server, (b) collect a first biometric sample from the biometric sensor, (b) compare the first biometric sample with the biometric profile, (c) determine whether the first biometric sample matches the biometric profile, (d) provide an indication as to whether the first biometric sample matches the biometric profile, (e) if the indication is that there is no match between the biometric profile and the first biometric sample, reject the financial purchase using the payment data set, and if the indication is that the biometric profile matches the biometric sample, then processing the payment data set to complete the financial purchase.

15. The transaction authorization system for authorizing a financial purchase of claim 14, wherein the payment data set comprises a credit card number and an expiration date.

16. The transaction authorization system for authorizing a financial purchase of claim 14, wherein the biometric profile comprises a facial recognition or fingerprint profile.

17. The transaction authorization system for authorizing a financial purchase of claim 16, wherein the biometric profile is collected by a sensor integrated into the payment token.

18. The transaction authorization system for authorizing a financial purchase of claim 10, wherein the payment token is a smartphone or a smart watch.

19. The transaction authorization system for authorizing a financial purchase of claim 1, wherein the biometric sensor comprises a LIDAR sensor.

20. An authorization system for processing an authorization request, comprising:
a token having an authorization data set and a biometric profile stored thereon, said biometric profile associated with a first authorized user of the authorization data set;
a biometric sensor for collecting biometric data from an individual;
a authorization terminal in electronic communication with the biometric sensor, wherein the authorization terminal or the biometric sensor includes a data processor having a microprocessor and software for instructing the microprocessor to (a) receive the biometric profile from the token and not from a remove server, (b) collect a first biometric sample from the biometric sensor, (b) compare the first biometric sample with the biometric profile, (c) determine whether the first biometric sample matches the biometric profile, (d) provide an indication as to whether the first biometric sample matches the biometric profile, (e) if the indication is that there is no match between the biometric profile and the first biometric sample, reject the authorization request using the authorization data set, and if the indication is that the biometric profile matches the biometric sample, then approving the authorization request using the authorization data set.
